(19) United States
(12) Patent Application Publication
(10) Pub. No.: US 2008/0220832 A1
(43) Pub. Date: Sep. 11, 2008

(54) Mobile Communications Station

(76) Inventors: Seppo Sellgren, Turku (FI); Mika Tarvonen, Littoinen (FI)

Correspondence Address: SCHWEGMAN, LUNDBERG & WOESSNER, P.A., P.O. BOX 2938, MINNEAPOLIS, MN, 55402, US

(21) Appl. No.: 11/667,094

(22) PCT Filed: Apr. 21, 2005
(86) PCT No.: PCT/FI05/50129

§ 371 Date: May 4, 2007

(30) Foreign Application Priority Data
Apr. 28, 2004 (FI) 20040596
Apr. 28, 2004 (FI) 20040599

(51) Int. Cl. H04M 1/02

(52) U.S. Cl. 455/575.3

(57) ABSTRACT

A mobile communications station (MS), which includes a first part (1) that can comprise a display (13) and a second part (2) that can comprise a keyboard (23), which parts are joined together and can be turned 360° apart from each other both against each other as well as to at least one intermediate position by using hinge means (5). According to the invention, there is arranged an aerial unit (6) of the mobile inside the hinge means (5).

The invention in question is connected to the communications. The target of the invention out in more detail is a mobile communications station, such as a mobile phone or a PDA device or corresponding terminal equipment of a wireless communications network, which mobile communications station is capable of a communication connection over a wireless connection with a public or closed wireless communication network and which mobile communications station includes an internal aerial unit and a first part and second part which can be turned/folded 360° in regard to each other by means of a hinge means.

Mobile phone, where there are the first part and the second that can be turned/folded 360°, is known from the publication JP2002171324. According to the principle of the publication, the turning/folding has been accomplished by a hinge means with two shafts. The publication does not, however, give any solution of an aerial solution, which is crucial to the function of the mobile phone. However, one can state that it is previously known, as such, that an aerial unit can be or can consist of the internal aerial unit or aerial element of the mobile phone. However, this kind of a solution cannot be adapted without problems for the mobile phone, which is in accordance with this JP publication, because the folding parts affect strongly an aerial field such that
in one position, that is in the open position, the aerial unit is near the cover of the mobile phone, in which case the aerial unit is on the front side of the mobile phone, and
in a second position, that is in a closed position, another part of the turning parts of the mobile phone turns over the aerial unit, in which case the aerial unit can be near the cover of the mobile phone only at the back side of the mobile phone.

The aerial field problem, which depends on a use position of the mobile phone, has been tried to solve earlier by carrying out in the mobile phone a hinge means with one shaft solution and by arranging the aerial unit inside this kind of a hinge means, in which case the aerial unit has been adapted to the vicinity of the end side of the mobile phone, whereby a mutual position of the parts of the mobile phone does not affect an aerial field essentially, because the aerial unit is essentially irrespective of parts of the position at the same distance from the front side or from the back side of the mobile phone. This kind of a solution has been presented in the publication, EP 1329981. However, the weakness of this kind of a solution is that the turning of the parts of the mobile is only about 180°.

One object of the invention in question is to eliminate or to reduce, at least essentially, the problems and weaknesses of the known technique. A second object of the present invention is to accomplish a new and inventive mobile phone, in which the usability of the mobile communications station has been improved in all its use positions irrespective of the fact whether the first part and the second part art turned against each other to either of the extreme positions or to an intermediate position between the extreme positions.

These objects have been reached over a cordless connection with a mobile communications station, such as a mobile phone or a PDA device or corresponding terminal equipment of a wireless communications network, which mobile communications station is capable of communication connection over a wireless connection with public or closed wireless communications network, which equipment is provided with an internal aerial unit or aerial element and which equipment includes a first part, where there can be a display unit, and a second part, where there can be a keyboard, which parts can be turned against each other and apart from each other by means of a hinge means, wherein the first said part and the second said part can be turned/folded 360° in regard to each other by means of the said hinge means and wherein the first said part and the second said part can be locked by means of the said hinge means to at least one intermediate position, which is between extreme positions, in which the angle between the first said part and the second said part is in the range of 100°-180°, advantageously about 180°, so that the aerial unit is arranged in side the hinge means such that path of electric signals to the part from the first said part and vice versa has been arranged to pass via the hinge means, that the said hinge means is connected to the first said part with at least one first hinge pin means and/or with at least one first joint pin means and/or with at least one first axis means or at least one first corresponding means, which makes possible the turning/folding of the first part and/or the second part, and that the said hinge means is connected to the second said part with at least one second hinge pin means and/or with at least one second joint pin means and/or with at least one second axis means and/or with at least one second corresponding means, which makes possible the turning/folding of the first part and/or the second part.

Then, it is advantageous, according to the invention, that the hinge means/pivot pin means and/or shaft means is loaded by a spring loads or the spring means reaches over the same, which spring means enforces the first part and the second parts apart from each other. The spring means can be for example a preloaded, advantageously at least one loading spiral spring, clock spring or blade spring.

Because the aerial unit has been arranged inside the hinge means, according to the invention, for example, the camera unit or any other accessory can be more freely adapted to the terminal equipment, for example optionally to the keyboard part and/or to the display part, which can be turned/folded in regard to each other, and to an optional side of the first half and/or the second part. Thanks to the hinge adaptation, which comprises two shafts, of the first part and the second part both thanks to the locking of the second part to the intermediate position, the terminal equipment can be used, for example on a desk top, as a conference phone, in which case the camera unit can show against the user of the terminal equipment.

The invention is described in the following by means of a referred embodiment there of, to which the present invention is not intended to be limited by any means, but several functionally and structurally equivalent alternatives and modifications are possible, with reference to the enclosed patent drawing, in which

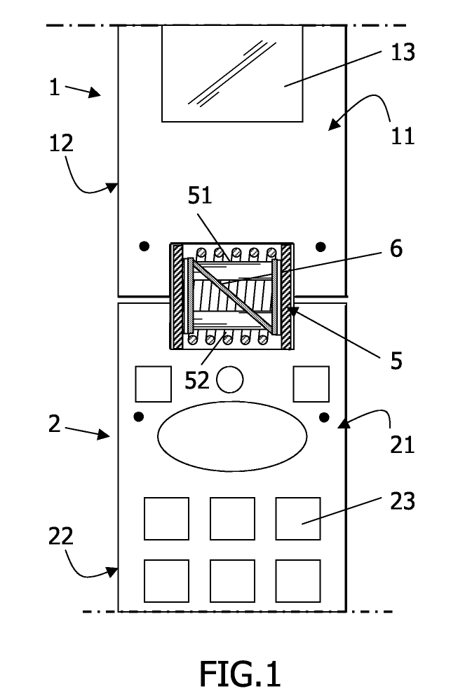

the figure FIG. 1 represents the mobile communications station according to the present invention as opened, and

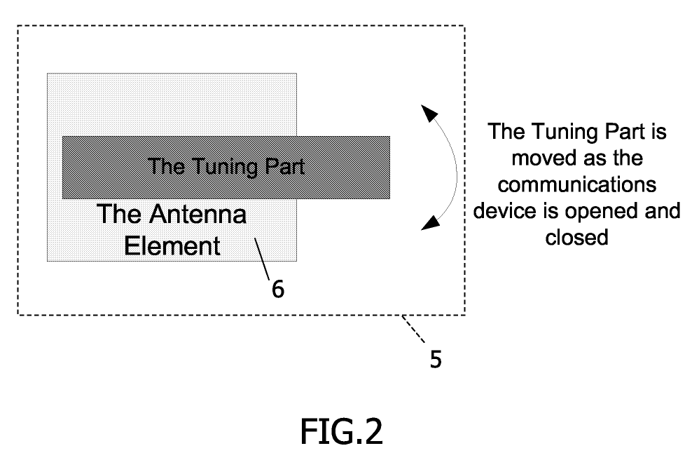

the figure FIG. 2 represents a general principle to correct weakened reception and/or transmission characteristics of an aerial.

There is presented in the figure FIG. 1 a mobile communications station (MS), such as a mobile phone, PDA device or a corresponding communications network terminal that is capable in a communications connection over a wireless connection with a public or a closed wireless communication network. In the following it is used a definition mobile phone from this kind of terminal equipment.

The mobile phone, which is in accordance with the figure FIG. 1, includes the internal aerial unit 6 or aerial element, to which it is referred for the sake of simplicity in the following by the definition aerial unit, a first part 1, in which there can be a display unit 13, and a second part 2, in which there can be keyboard 23, which first part and second part are connected to each other and can be turned apart each other as well as against each other by means of a hinge means 5. Because the hinge means, which is in accordance with the invention, comprises two shafts the first part and the second part can be turned/folded folded in regard to each other 360° in other words between extreme positions by means of the hinge means. Furthermore, the first part and the second part can be locked by means of the hinge means, which is in accordance with the invention, at least to one intermediate position, which is between the extreme positions. In the intermediate position an angle between the first part and the second part is in the range of 100°-180°, advantageously about 180°.

To understand the invention, it is stated as follows. In the first extreme position, the first side 11 or the first front side of the first part 1, which includes the display unit 13, and the first side 21 or the second front side of the second part 2, which includes the keyboard 23, are against each other, in which case the folding mobile phone, in other words the so-called shell phone or flap phone is in the closed position. In the closed position, the second side 12 or the first back side, in which there can be an additional display of the mobile phone, and the side 22 or a second back side of the second part are visible. In the second extreme position of the mobile phone, the second side 12 or the first back side, in which there can be the additional display unit, and the second side 22 or the second back side are against, in which case the folding mobile phone or so called shell phone or flap phone is in the position, in which the display unit 13 and the keyboard 23 are on the opposite sides of the mobile phone.

In order to accomplish the general object of the invention, that the aerial unit, which is inside the hinge means 5, in combination with the turning of 360°, the aerial unit 6 is arranged inside the hinge means so that the route of electric signals will pass through the hinge means from first part 1 to second part 2 and vice versa. Additionally, to reach the general object of the invention, it is characteristic that the hinge means is connected to the first part with a first shaft pin means 51 and/or pivot pin means and/or axis means or by a corresponding means that makes possible to turn/fold the first part and/or the second part, and that the hinge means is connected to the second part with a second shaft pin means 52 and/or pivot pin means and/or axis means or by a corresponding means that makes possible to turn/fold the first part and/or the second part.

Because in mobile phone, which is in accordance with the invention, the first, part 1 and the second part 2 are fasten to each other as head-to-head or by a small close distance there between, and because the hinge means 5 comprises two shafts 51, 52, it will become possible the fact that the first part and another part can be moved by means of the hinge means while retaining their mutual orientation so that the terminal equipment can be in the desktop use in the position, in which position there are against the surface of the table for example the keyboard part's free end edge and edge of the hinge means, to which a display part is connected, in which case the keyboard part is in the position that has been a little tilted and the camera unit can show better towards the user of the terminal equipment.

The shaft pin means of the hinge means can also be a two-piece element (not presented in the figures), in which case the same extends as separate pin means from the hinge means 5 to first part 1 and/or to second part 2 of the mobile phone. The shaft pin means 51, 52 of the hinge means can be a single element, in which case the same extends as uniform cross the hinge means 5 to the first part 1 and/or to the second part 2 of the mobile phone. The length choice for this kind of single-type or two-piece type hinge means is not essential to the present invention but the length of the hinge means can be chosen to extend
at both sides of hinge means 5 only inside the first part 1 and/or the second part 2 of the mobile phone, in which case the shaft pin means is not visible at the side edge of the mobile phone, or
at both sides of the hinge means 5 through the first part 1 and/or the second part 2 of the mobile phone, in which case the shaft pin means 51, 52 can be visible at side edge of the first part and/or the second part.

It is advantageous that the first part 1 and the and second part 2 of the mobile phone can be locked between the extreme positions at least to one intermediate position. In this intermediate position the angle between the surfaces of the first part and the second part, which can be turned against each other, can be about 100°-180°. However, it is advantageous, that the angle is about. 180°. For the accomplishing that to the intermediate position locking turning/folding, it is, according to the invention, advantageous that in the hinge means 5 the shaft pin means 51, 52 is loaded by or at least one loading spring extends over the same, which loading spring enforces the first parts 1 and the second part 2 of the mobile communications stations apart from each other to the intermediate position. The loading spring can be for example, a preloaded spiral spring 531 or a clock spring or a blade spring 532 (FIG. 1).

In practice, there can happen situations, in which the reliability of the mobile phone or transmission properties or receiving properties of the aerial unit are decreased, due to an uneven aerial field or due to a changing aerial field and/or due to a limiting aerial field.

The figure FIG. 2 represents in general an adjustment solution principle to be arranged in the hinge means 5 to correct the problem situation of the aerial, in other words to tune the aerial.

According to the invention, the tuning can be re-established or can be improved by means of the mechanism, i.e. a tuning organ 7, which as a consequence of the opening/closing of the device or by following the same correspondingly adjusts the tuning of the aerial again. According to the solution of the figure FIG. 2, there is arranged either a leading (typically metallic) or a dielectric (plastics, ceramic or a corresponding tuning organ in charges in the neighbouring field of the aerial unit and/or in the vicinity of the same. In that case, the function of the aerial unit will improve, because the tuning of the aerial unit that is arranged inside the hinge means adjusts again depending on the opening movement and closing movement of the mobile phone. A solution that functions in an equivalent way is possible to carry out also by moving, that is by bending or by twisting or by stretching or by another corresponding way, or by re-shaping the aerial unit 6 or the ground plane of the aerial unit or the foundation of the aerial unit.

The invention has been described above only by means of one preferred embodiment example. Naturally by this approach, the invention is not intended to be limited to concern only such an individual embodiment example and many functionally alternative and equivalent modifications and solutions are possible within the scope of protection that is defined by the enclosed claims.

1. Mobile communications station capable of communication connection over a wireless connection with public or closed wireless communications network, which equipment is provided with an internal aerial unit or aerial element and which equipment includes a first part, where there can be a display unit, and a second part, where there can be a keyboard, which parts can be turned against each other and apart from each other by means of a hinge means, wherein the first said part and the second said part can be turned/folded 360° in regard to each other by means of the said hinge means and wherein the first said part and the second said part can be locked by means of the said hinge means to at least one intermediate position, which is between extreme positions, in which the angle between the first said part and the second said part is in the range of 100°-180°, advantageously about 180°, characterized in that the aerial unit is arranged in side the hinge means such that path of electric signals to the part from the first said part and vice versa has been arranged to pass via the hinge means, that the said hinge means is connected to the first said part with at least one first hinge pin means and/or with at least one first joint pin means and/or with at least one first axis means or at least one first corresponding means, which makes possible the turning/folding of the first part and/or the second part, and that the said hinge means is connected to the second said part with at least one second hinge pin means and/or with at least one second joint pin means and/or with at least one second axis means and/or with at least one second corresponding means, which makes possible the turning/folding of the first part and/or the second part,

2. A mobile communications station according to claim 1, characterized in that a loading spring loads or reaches over the hinge pin means/joint pin means and/or axis means, which loading spring enforces the first part and the second part of the mobile communications station from each other apart.

3. A mobile communications station according to claim 2, characterized in that the loading spring is a pre-tensioned, advantageously at least one spiral spring, clock spring or blade spring.

4. A mobile communications station according to claim 1, further comprising a tuning organ inside the hinge means of the first part and the second part which are movable in regard to each other, in order to compensate weakening and changes of the tuning as well as qualities and/or parameters of the aerial unit that are caused of changes of a mutual position and mutual distance of the electrically conductive parts of the mobile communications station.

5. A mobile communications station according to claim 4, characterized in that the tuning organ of an adjustment solution or an tuning solution, which is inside the hinge means is automatic and improves in the nearby field of the aerial unit the tuning of the aerial unit by following or observing the opening and/or the closing of the mobile communications station hence by adjusting correspondingly the tuning of the aerial unit.

6. A mobile communications station claim 4 wherein the tuning of the aerial unit comes true when the tuning organ, which is selectively conductive, that is metallic or dielectric, that is plastics, ceramics or corresponding, of the adjustment solution or the tuning solution comes to the vicinity of the aerial field.

7. A mobile communications station according to claim 4, wherein the tuning for the aerial unit adjusts again, when the tuning organ of the adjustment solution or the tuning solution of the aerial unit when moves depending on the opening and closing of the communications device.

8. A mobile communications station claim 4, wherein the tuning of the aerial unit can be carried out by moving or by forming, for example a pending or a twisting or a stretching or a corresponding manner, the aerial unit or a ground level of the aerial unit or a foundation of the aerial unit.

9. A mobile communications station according to claim 1, wherein the first part and the second part can be moved retaining their mutual orientation by means of the hinge means such that that the terminal equipment can be, for example in a laptop use, in a position in which, for example the free end edge of the second part and an edge of the hinge means are against the surface of the table, in which case the second part is in a little tilted orientation towards the user of the terminal equipment and a possible camera unit can be directed better towards the user of the terminal equipment.

10. The mobile communications station according to claim 2, further comprising a tuning organ inside the hinge means of the first part and the second part which are movable in regard to each other, in order to compensate weakening and changes of the tuning as well as qualities and/or parameters of the aerial unit that are caused of changes of a mutual position and mutual distance of the electrically conductive parts of the mobile communications station.

11. The mobile communications station according to claim 10, wherein the tuning organ of an adjustment solution or an tuning solution, which is inside the hinge means is automatic and improves in the nearby field of the aerial unit the tuning of the aerial unit by following or observing the opening and/or the closing of the mobile communications station hence by adjusting correspondingly the tuning of the aerial unit.

12. The mobile communications station claim 4, wherein the tuning of the aerial unit comes true when the tuning organ, which is selectively conductive, that is metallic or dielectric, that is plastics, ceramics or corresponding, of the adjustment solution or the tuning solution comes to the vicinity of the aerial field.
